(19) United States
(12) Patent Application Publication
(10) Pub. No.: US 2002/0194045 A1
(43) Pub. Date: Dec. 19, 2002

(54) System and method for automatically allocating and de-allocating resources and services

(76) Inventors: Izhar Shay, Fairlawn, NJ (US); Amir Weinstein, Petach Tikva (IL); David A. Lavenda, Wesley Hills, NY (US); Chaim Amram, Zoran (IL); Roy Rotem, San Mateo, CA (US)

Correspondence Address: Hale and Dorr LLP, 1455 Pennsylvania Avenue, N.W., Washington, DC, 20004, US

(21) Appl. No.: 10/134,688

(22) Filed: Apr. 30, 2002

Related U.S. Application Data
(60) Provisional application No. 60/287,399, filed on May 1, 2001.

(51) Int. Cl. G06F 17/60

(52) U.S. Cl. 705/8; 705/1

(57) ABSTRACT

A computer-assisted method, system, medium of allocating resources within an organization. For instance, the method includes the steps of receiving a request containing at least one business change relating to allocating the resources within the organization, and generating at least one task to implement the requested business change. The method may also include the steps of identifying at least one of a person capable of handling the at least one task and a software module configured to perform the at least one task and issuing at least one instruction to the at least one of a person capable of handling the at least one task and a software module configured to perform the at least one task. These steps may allocate the resources within the organization in accordance with the at least one business change.

### FIELD OF THE INVENTION

The present invention is directed to a system and method that uses business requirements to automatically allocate or de-allocate resources and services, and more particularly, to a system and method for responding to changes in an organization by automatically allocating and/or re-allocating enterprise resources and services.

### BACKGROUND OF THE INVENTION

Organizations are keenly aware of the challenges posed by the “information” age. Most, if not all, organizations rely upon Information Technologies (“IT”) and automation to do business. The rapid movement of information, expedited by the proliferation of intranets, extranets and the Internet, has elevated the strategic importance of IT. The infrastructure that contains the information needed to leverage resources, however, is often decentralized and difficult to access. While the possibilities for development and innovation have never been greater, the need to synchronize business strategies to ever-changing IT has become the crucial challenge on today's path to success.

Generally, today's businesses have tens or hundreds of resources. Each of these resources may be in different locations, with different access and control features. At the typical rate of corporate growth, resource management is a daunting task. This is especially true in today's environment where change is the norm. For example, if a business desires to add a new business partner, dozens of systems might need to be adjusted. It is necessary to mobilize various personnel, possibly for completely unrelated tasks, who would then be responsible for implementing the changes. Some examples of these disparate tasks include configuring firewalls and virtual private networks (“VPNs”), electronically enrolling them in specific partner programs, providing new user, email and groupware accounts, as well as associating people with specific groups within applications. The entire setup process becomes extremely complex—merely communicating back and forth between management and IT, and providing oversight and control is time consuming and error prone.

The same is true with respect to employees, temporary employees, contractors, consultants or other personnel within organizations. Every day organizations are faced with changes to their work force. These changes could be the addition of a new person, the relocation of an employee or group of employees to a new facility, the suspension or re-activation of a temporary employee, or the termination of a contractor. Because technology is increasingly putting pressure on business to accelerate, it has become increasingly important for organizations to provide personnel with instant access to the tools they need to get their jobs done. These tools can include their physical workspace, computers, cell phones, mobile devices, software, accounts on internal and external systems, mailing and other distribution lists, and even business cards. Each workforce change event requires the organization to take a number of steps to implement the change including the allocation or de-allocation of resources. In the fast paced business world, it is imperative to get people set up quickly, to ensure consistency in resource allocation, to provide accountability for resource usage, to keep people connected over time and to keep the business secure when people leave.

Exactly how do present day organizations handle these changes? For example, in the case of a new employee, typically a business manager is charged with ensuring that an employee has all the resources he or she needs to do their job. This involves lots of overhead (telephone calls, email, faxes, etc.). The business manager has to contact many different people, since resources are typically handled by different departments/people.

While various technologies may be in place to control the management and allocation of these tools, they often work independently of one another, are scattered throughout the enterprise, and require manual handling and processing. Organizations need assistance to better manage change and growth on any level with agility, control, and efficiency.

Organizations presently lack the technology and resources to successfully integrate strategic business needs with resource allocation. While technology is in place to support the needs of the business, it has become an impossible task to control the information stored around the digital infrastructure of intranets and extranets, from a business perspective. To do so requires systematic, inter-departmental, inter-disciplinary collaboration within the organization and the necessary technology to synergize business-driven IT activities.

### SUMMARY OF THE INVENTION

The present invention overcomes the shortcomings discussed above by replacing many of the activities performed by the traditional business manager responsible for deploying employees, contractors, consultants, temporary employees, business partners and the like, in, moved, or out of the system with a system and method for automatically allocating and/or de-allocating resources and services based upon business requirements. Activities are initiated and defined in “business terms” by business managers. In this way, the infrastructure truly serves the business. There is no need to determine what a person needs to do their job when allocating resources.

The present invention helps organizations to build and evolve their infrastructures to support business growth by automating core provisioning and workflow activities, transforming traditional business processes into dynamic, flexible processes. The present invention converts directory-based information into business change profiles, using a business-oriented workflow engine to dynamically allocate the appropriate resources for individual users—including access names and passwords, email and network accounts, productivity applications, PCs, cellular phones, and more. This is accomplished by tracking a user through the business cycle from start to finish, recording changes to name, location, status, and more—and automatically updating provisioned resources accordingly. When the cycle ends, assigned resources are systematically and securely removed at the appropriate time.

The dynamic workflow process of the present invention includes the steps of defining a business change, generating a business change profile, generating activities to realize a desired profile, notifying at least one approver for each activity requiring approval, implementing the approved activities to ensure that the business change is implemented, and, logging the activities thereby maintaining the integrity of the business change process.

The present invention enables users to monitor and implement provisioning activities through a user interface. The interface allows a business manager to preview a resource profile. For example, a business decision is made to hire an employee, enter a new customer, change the status of an employee or remove an employee. A summary of the information changed in a personnel card is displayed on the user interface. The business change profile, which includes the details of resources that will be allocated or de-allocated, is generated and displayed on the interface, allowing a user to reject the changes, accept them, or make manual changes and then confirm the changes. After the business change is approved, the appropriate activities are generated to implement it. The responsible manager can view the details of each activity and then, if appropriate, approve the activities. In addition, the manager can view the status of all the activities in the organization.

After the activities are approved, specific manual tasks are distributed to the appropriate employees. Each employee implements the tasks assigned to him/her to carry out the business change requirements.

### BRIEF DESCRIPTION OF THE DRAWINGS

The detailed description of a preferred embodiment of the present invention showing various distinctive features over prior art may be best understood when the detailed description is read in reference to the appended drawing in which:

FIG. 1 illustrates an exemplary business environment for employing the present invention;

FIG. 2 illustrates various functional features of the present invention;

FIG. 3 illustrates a technical architecture of the present invention;

FIG. 4 illustrates business change translation of the present invention;

FIG. 5 illustrates relationships among business change and other features of the present invention; and

FIG. 6 is a state diagram that illustrates a life cycle of a task of the present invention.

### DETAILED DESCRIPTION

A system and method for using business requirements to allocate and/or de-allocate resources and services automatically is described. In the following detailed description, numerous specific details are set forth regarding the system and method and the environment in which the system and method may operate, etc., in order to provide a thorough understanding of the present invention. It will be apparent, however, to one skilled in the art that the present invention may be practiced without such specific details. In other instances, well-known components, structures and techniques have not been shown in detail to avoid unnecessarily obscuring the subject matter of the present invention. Also, the same reference numerals are used in the drawings and in the description to refer to the same elements.

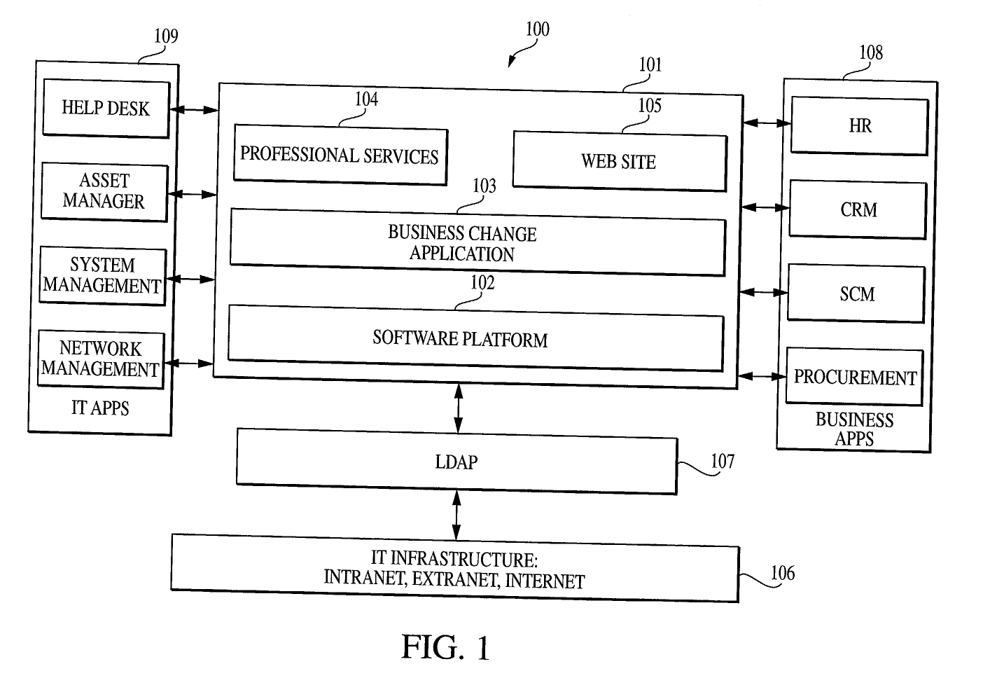

Referring now to the drawings and, initially to FIG. 1, there is illustrated an exemplary environment 100 for the present invention. A system 101 includes components of the present invention. The remaining illustrated components represent the surrounding business and technical environment. A software platform 102 is the basis upon which the present invention is built. This software platform 102 provides core functionality that is used by the various applications of the present invention.

The software platform 102 includes a number of modules that perform the tasks required to automatically allocate and/or de-allocate resources and services. These modules (not illustrated) include a Business-Resource Translation Engine, a database, an Event Logging Facility, a Messaging Queue, a Workflow Engine, and a Web Server.

The Business-Resource Translation Engine is a software module that translates “business changes” (described below) to an individual's requirements from organizational resources and services. The database stores runtime and system configuration data. The Workflow Engine (described below) is a software module that launches tasks, synchronizes them, collects status reports and follows the process of the present invention as it progress through a workflow. The Event Logging Facility is a log containing every provisioning event, system alert and failure. The Messaging Queue is used as a persistent, asynchronous message-oriented channel connecting various processes. The Web Server acts as the system of the present invention's server interface to web-based clients.

A “business change” as used herein is any change to a person's “business” profile. Examples of business changes include, but are not limited to the following: hiring a new employee, moving a person between sites, a person changing his/her name, a person changing their telephone number, or terminating an employee. Business changes can also be applied to customers, business partners, supply chain partners, contractors and temporary employees. A business change may be entered into the system of the present invention via the application's web-based client interface, e.g., the web server. The user, typically a Human Resources (HR) or business manager, enters the change. For example, an HR manager might specify that an employee is moving from New York to San Diego. The HR manager would therefore change the employee's “work site” definition from “New York” to “San Diego.” This change automatically triggers the system and method of the present invention to set up a workflow that makes sure the employee will have the proper resources and services in San Diego. It also makes sure the employee is “out of the system” in New York, once the move is made.

Alternatively business changes can be entered through any existing business system such as HR, CRM, SCM HR applications, which are available from PeopleSoft, Inc. of Pleasanton, Calif. or ERP HR application, which is available from SAP AG of Walldorf, Germany. The change in these systems can trigger the same processes of the present invention as if the change was done using the present invention's web-based client interface.

The software platform 102 employs a Business Change Profile (“BCP”), which are data objects that contain all the attributes of a person in an organization. An attribute is an atomic amount of information that describes an individual or their use of resources and services. Examples of attributes include but are not limited to the following: family name, business address, home address, job title, office telephone number, voice mail password, operating system, e.g., Windows NT®, account username, desktop PC type, amount of desktop Random Access Memory (“RAM”), etc. An individual's BCP may for example typically contain hundreds of attributes.

A Business Change Application (“BCA”) module 103 enables the present invention to handle numerous change management tasks. Specifically, this module handles the input requirements associated with New, Change, Move, Terminate, Suspend, and Reinstate business changes. The present invention provides an interface that allows other type of Change Applications to be developed.

The BCA module 103 handles the specifics associated with each class of person in the system. Besides internal personnel such as employees or contractors, it provides the present invention's capability for inter-organizational engagements such as, supply chains, dealer engagements, customer networks, and other types of extranets, as well as e-marketplaces, to name a few.

A Professional Services module 104 enables the integration of the software platform 102 into the organization's business and IT environments. Integration includes, but is not limited to the following activities:

Defining and creating personnel business and resource profiles.

Creating rules that map personnel business profiles to the resources and services that each person will need to do their job.

Customizing the application's user interface.

Connecting the application of the present invention to the organization's business and IT systems.

Creating organization-specific reports.

Ongoing management and maintenance of the solution of the present invention.

A web site 105 is included to provide a user interface to the present invention. The web site 105 provides services that allow companies to subscribe to the use of the current invention. By accessing the web site 105, a user can obtain access to the following services:

Technical support.

Content such as application notes, white papers, and hot links to other sources of information.

Profile-specific links to suppliers of IT products services

Community—a place to trade information with other users of the present invention.

Customer-only web site—a source for patches, upgrades and new software modules consulting services.

Application Service Provider (“ASP”) sign up area—a web site location that allows companies to purchase new services or extend existing services.

Communications channel—a mechanism to automatically provide an organization's system administrator with latest news and services available.

Next is described the blocks surrounding the system 101 of the present invention in FIG. 1. An IT infrastructure 106 comprises the sum total of all assets and services that contain information or facilitate information exchange within or between organizations. Some examples of entities that comprise the IT infrastructure 106 include, but are not limited to: data network (intranet, extranet, Internet), voice network (telephones, PBX, etc.), software applications, databases, personal computers, handheld computing devices, voice mail, data loggers, remote access servers, pagers, cell phones, email, groupware, etc. Note that parts of an organization's IT infrastructure 106 may reside outside organization boundaries. For example, applications leased from an ASP are part of the organization's IT infrastructure, although they may be physically located on another organization's premises.

Included in block 107 are directories, which are special purpose databases optimized for reading, writing, and managing “profiles.” Profile information is a set of data about a person or resource that is changed infrequently, but referenced (i.e., read) frequently. Directories and the services needed to manage them are commonly referred to as “directory services.” The Lightweight Directory Access Protocol (“LDAP”) is a standard way to name, manage, and access collections of directory profiles. An increasing number of applications and devices store their user profile information in an organization's centralized LDAP directory. Since this profile information can be retrieved in a standard manner, many applications and servers can share common user definitions. LDAP is an Internet Engineering Task Force (IETF) standard as published in a set of Request for Comment (RFC) documents, including RFC 2251. Sharing user profiles across applications simplifies the managing of user profiles. The present invention leverages this “centralization of data” to streamline and automate the configuration and set up of many applications, devices, and services.

The present invention stores its BCP information in a standard LDAP directory. This makes all user-profile information accessible to authorized employees in a standard, secure, and reliable fashion. More importantly, it means that the present invention can directly enforce network device configuration and the set up of user accounts and group associations for many applications, simply by managing the user profiles in its LDAP directory. The present invention will run over any standard LDAP directory. Exemplary LDAP directories that can be utilized by the present invention include Novell's NDS (eDirectory) version 8.x available from Novell, Inc. of Provo, Utah, iPlanet's Directory Server version 4.3 from iPlanet eCommerce Solutions of Palo Alto, Calif., Microsoft's Active Directory available from the Microsoft Corporation of Redmond, Wash., and IBM's Secureway Directory 3.1 available from the IBM Corporation of Armonk, N.Y.

Business Applications 108 are business systems that are already available to an organization. A robust Application Program Interface (“API”) allows integration of business systems within the Business Applications 108 with the software platform 102. Exemplary business systems include, but are not limited to the following:

Human Resource applications—employee change information is entered via the Human Resource application. Changes to this application will trigger the present invention to process a business change.

Billing systems—the present invention logs each IT activity and resource use. This information can be passed to a billing system to process internal chargebacks for use of resources and services.

Reporting tools—in addition to its own report generator, the present invention can pass IT activity information to additional reporting tools for inclusion in reports.

Procurement systems—the present invention can pass purchase orders for IT equipment to procurement systems.

The present invention is designed to interface with IT Applications 109 that are already part of the infrastructure of an organization. A robust API allows integration of the software platform 102 with the IT Applications 109. Exemplary IT Applications 109 include, but are not limited to the following:

Help Desk—manual tasks generated by the present invention can be passed to a Help Desk for processing by the help desk staff. Changes in task status can be passed back to the present invention, so one, unified view of all IT activities can be maintained.

Asset Management tool—an IT profile can be associated with organizational assets. For example, if the IT profile specifies an employee has a PC, this information can directly point to a corresponding record in the asset management database.

System Management—the results of automatic and manual tasks executed by the present invention can be passed to IT applications that manage the functioning of various groups of IT applications. The information can update the view presented at a console from which administrators monitor and manage the status of many software applications.

Network Management—the results of automatic and manual tasks executed by the present invention can be passed to IT applications that manage the functioning of various network devices. The information can update the view presented at a console from which administrators monitor and manage the status of the network.

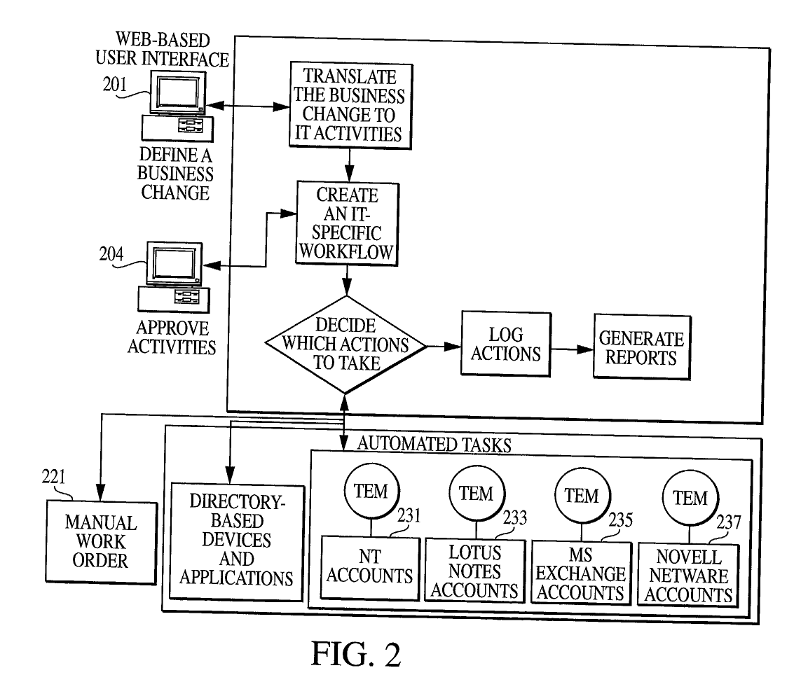

The above-described environment 100 is further described in context of functional features by referring to FIG. 2 and in context of a business change application (“BCA”). The BCA is a business application built upon the software platform 102. In particular, the functional features of the BCA include the steps of defining a business change 201, translating the business change to If activities 203, and creating a Business Change specific workflow 205. Before executing the Business Change specific workflow 205, an approval of activities specified in the workflow is optionally required 207. Once the approval is granted, the present invention performs the step of determining which one or more of the specified actions to be taken 209. Subsequently, the present invention includes the steps of logging the activities 211 and generating a report 213. These steps are described in more detail below.

In the step of defining a business change 201, a business change can be any modification of a person's business profile. As described above, a business change can be one or more of the following: hiring a new employee, temporary employee, or contractor; moving a person from one site to another; changing a person's job title; transitioning an person from one project to another; joining a person to a task force; changing an person's name (e.g., marriage); changing employment status of an employee (e.g., a leave of absence, or change from contractor to employee), terminating a person, or adding or removing new business partners (like customers, suppliers, or resellers). In a related feature, a business process (“BP”) may be triggered by an operator (e.g., a business manager or Human Resources manager) when the operator defines a business change via a graphical user interface. Alternatively, a BP may be triggered automatically by a business application, such as Peoplesoft HR application.

In the step of translating the business change to resource allocation activities 203, one or more of the business changes exemplified above are translated to a collection of BPs. This collection of BPs is preferably carried out by a collection of tasks, either automatically or manually, thereby properly allocating resources.

In order to provide the context to the above step of translating the business change to tasks, three types of variables attributable to a person for the purposes of present invention are described: a role, a rule and a policy.

A role defines a person into a class (e.g., an employee, temporary employee, approver, systems administrator, and the like). It should be noted a person can be defined into more than one class. For instance, a person can be an employee and a system administrator.

A policy defines how to allocate resources to a particular class or class of persons. For instance, a person with an executive role may require an executive level of resources (e.g., a larger office, high-end computers, etc.) while a person with a system administrator role would require a different level of resources.

A rule modifies policies of a person belonging to a particular class. For instance a person's role might be a sales person. As a class, sales persons would be assigned with one set of policies. However, a sales person in Boston may require a different set of resources than a sales person in Washington, D.C. The rules capture the different resources required in individualized situations. In other words, the rules operate as exceptions to policies.

In embodiments of the present invention, roles, rules and/or policies attributed to a person change when a business change occurs to that person. According to the changes made in the roles, rules and policies, processes/tasks are generated. This step is referred as the translation step 203. In other words, during the translation step, a business change is transformed into a number of processes and tasks to be performed, which are generated based on the business change that caused changes in roles, rules and policies.

An example of a business change and its corresponding processes/tasks may relate to a situation when, for example, a new engineer is hired who will work on a particular project (e.g., the TITAN project) at a particular location (e.g., the Boston Development center). In this example, the business change is hiring a new engineer. This causes changes in roles, rules and/or policies, which in turn generate the following exemplary processes/tasks: supplying a PC with a specific hardware profile to the new engineer; purchasing and then installing a set of software applications; calculating and then automating the setup of a telephone extension number and all associated voice services—down to the PBX level; calculating an available email address, setting up an MS-Exchange account, and adding the new engineer to email distribution lists; setting up Windows NT® accounts and add the employee to a specific domain; setting up Unix accounts; setting up Lotus Notes accounts; and/or establishing Dial-in access to specific servers. The set of activities may also include printing business cards, finding a physical workspace for the new employee and supplying an employee's handbook (and making sure its receipt was acknowledged). The set of processes/tasks may go as far as sending email notifications to all affected parties of the pending arrival of the employee to insure they are expected and properly attended to.

Another example of a business change and its corresponding processes/tasks may relate to a situation where an employee moves from one facility to another facility (e.g., Boston to San Diego) and at the same time transfers between departments. In this example, the business change is moving the employee from one location to another and from one department to another. This causes changes in roles, rules and/or policies, which in turn generate the following exemplary processes/tasks: recalculating email distribution lists and automatically deleting/adding membership as per company policy; recalculating the NT domain membership and automatically deleting/adding membership as per company policy; recalculating telephone extensions and automatically update all voice services; and/or updating the employee's contact database and then downloading it to their cell phone/hand held computer.

In yet another example of a business change and its corresponding processes/tasks may relate to a situation where an employee leaves the company. In this example, the business change is an employee leaving a post. This causes changes in roles, rules and/or policies, which in turn generate the following exemplary processes/tasks: automatically redirecting all incoming mail to the employee's replacement; automatically transferring all user files to a “holding area”; if the files are not needed after six months, automatically deleting them; automatically disabling user accounts, e.g., NT, Unix, Lotus Notes, etc., and/or automatically disabling voice services.

In yet one more example of a business change and its corresponding processes/tasks may relate to a situation where a supplier hires a new engineer that will need access to the manufacturer's internal resources. In this case, processes/tasks generated by the Business-to-Resource Translation Engine may include gaining specific access to internal web-based applications, remote access rights, and addition to email distribution lists.

The above described activities (e.g., business changes, processes and tasks) can be described as follows: a process is collection of tasks, and, in turn, a business change is a collection of processes. In the examples provided above, a business change can be adding a new employee, a process can be providing a new computer for the new employee, and tasks can be filling out a computer acquisition request form, receiving approval for the request, contacting a vendor to purchase the computer, etc.

In the step of creating a Business Change specific workflow 205, the tasks, identified in the translation step, are initiated (e.g., “buy a computer before installing software”). Some tasks are fully automated by the invention. Others are assigned to a person or class for completion. Before actual assignment of the tasks, the activities are preferably put on hold until they are optionally approved by a person of sufficient authority (e.g., a business manager) to approve such activities (step 207).

In the step of determining which one or more of the specified actions to be taken 209, embodiments of the present invention determine which of those activities are to be carried out manually and which ones automatically. The present invention also determines the sequence of the tasks based on dependencies they may have to each other or to data generated by the tasks (e.g., you cannot install software on a laptop until it has been purchased and received, or you cannot create a Microsoft Exchange mailbox until the data from the NT account creation is available).

For those activities to be carried out manually, work orders for manual tasks (e.g., installing equipment) are delegated to the appropriate personnel (as defined in the system) (step 211), e.g., via email or via web-based “To Do” lists. Failure to execute on these tasks within an allotted time period triggers an escalation process, which causes an investigation, corrective actions and/or retries.

For those activities to be carried out automatically, these tasks may be executed by one of the following methods:

i) Manipulation of the BCP within the directory, for directory-enabled applications (e.g., Peoplesoft HR application) and devices; and

ii) Execution by one or more Task Execution Modules (TEMs) or “connectors” (described later) that go out into the IT environment and configure devices and applications via scripts.

The BCA includes an application programming interface (API) that allows third parties to automatically connect to devices and applications. User registration via ASPs is an example of a TEM that can be created using the API. This allows outsourcing the enterprise applications using Application Service Providers (ASPs).

Embodiments of the present invention, via the above-described environment and functionality, provide many advantages. The advantages of the present invention include allocation of resources in highly mobile or transitional organizations, creation of “projects,” the consistent execution and enforcement of the business policies governing resource allocation, the inclusion of a special “observer” role, and the availability of a “white page” application. A white pages application allows people in the organization to search for contact information about other people within the organization or within the extended organization. The white pages application may also include various search tools. These features are described below in detail.

With respect to the allocation of resources, when a person moves to a new site or changes job title, a task(s) can be set up to automatically update all resources that need to reflect the change. These resources can include, but are not limited to, email distribution lists, IT domains, phone and address lists, and any other resource that includes job specific details like business cards.

With respect to the creation of “projects,” the BCA allows business managers to create “projects.” A project is any business change that can be applied to a pre-selected class of employees. This feature allows a uniform application of similar processes/tasks. This feature alone is a time saver, ensuring fast and consistent changes for all members of a class.

Further, the project interface can apply a common information element, task, or business change to a class of people with dissimilar profiles. Consider the benefits of the following scenario. A company wants to move employees to a newly constructed site (e.g., San Diego). The employees currently reside in St. Louis, Houston, and New York. Because the employees reside in three different sites, they currently have different profiles that take into account site-specific issues like their email addresses or NT domain affiliations. After creating a project with all of the people to be moved, a person of sufficient authority is only required to enter “San Diego” in the site field of the template screen. For each selected employee, the BCA analyzes their current profile, creates a template of what their profile would resemble in the new location, creates a Business Change Profile that contains both sets of values and the information on the tasks required to accomplish the desired change, creates the workflow, and finally executes the workflow. The tasks can include the fully automatic transfer of all relevant information and resources, between IT systems at the originating and destination locations. This feature represents substantial cost and time savings compared to existing techniques that require each individual to be addressed manually.

In addition, BCA allows registering a new employee by setting an “end date” that signifies the date by which the employee will leave the company. For example, when registering a new contract worker that is hired for three months, a process can then be automatically generated to specify that at the end of the three months, access to all systems will be revoked. Of course, this decision can be pegged to an approval process, so that in the event the worker is retained, access can be maintained. This feature allows handling temporary employees and contractors. This feature is extremely advantageous for organizations with a high degree of transient users. (Note—students in a university fit this profile as well as do seasonal employees in retail chains.)

With respect to creation of “white pages,” a list of contact information is provided to the general employee population. Employees can search for contact information about other employees via a simple browser interface. The permission to view and edit data is controlled (via user level permissions) and the data is protected inside the LDAP directory. Employees can search for fellow employees using any set of attributes in the LDAP directory.

Users can search for employee information using either a search tool or using the company “browser,” which displays employee lists by department or geographical location. The “browse” tool is similar in concept to the Windows Explorer tool for files available from Microsoft Corporation of Redmond, Wash.

Using the “Query” and “Search” Tools, IT personnel logged into the BCA can quickly and efficiently find employee information. For example, IT personnel may need to locate a person who can approve purchases, and an IT manager may want to view all the employees whose IT setup are not completed, etc. The Query Tool supports the following query types:

Simple—single search criterion (e.g., last name=“Jones”); and

Compound—multiple search criteria (e.g., last name=“Jones” and location=“New York”).

In addition to query and search, a Browser Tool is provided so that IT personnel can locate employees using a top/down approach, based on department or geographical locations. For example, one could easily view all the employees located in one office (e.g., the Wall Street office) by continually drilling down on the BCA's organizational tree.

With respect to the consistent execution and enforcement of the business policies governing resource allocation, the present invention provides an additional value in that it prevents the problems that arise when individuals bypass corporate policy and create resource allocations at the behest of others in the enterprise or for malicious purposes.

With respect to the workflow, the present invention provides an additional value in the form of a special role labeled “observer”. Any process or task can have associated with it an observer, which is a person that is notified of the execution, completion, and escalation of the task separate from the approvers, escalators, or the people, designated to execute the task (for manual tasks). The purpose of the observer is to send a notification to someone who is affected by the execution of the task but is not necessarily responsible for it. An example of the use of the observer would be to notify a line of business manager that the computer required for a new employee will not be available. The notification may contain notes made by the performer or escalator, and may include a new projected date for the resolution of the task or process.

Now turning to describe Task Execution Modules (TEMs) (e.g., connectors), as mentioned above, automatic tasks are executed by using connectors. A TEM is a software module that automatically executes a task (e.g., opening a new NT account for a new employee). More specifically, a TEM includes a script or executable file containing instructions that automatically execute a task. The TEM uses parameters that determine the execution mode and specific runtime values, such as account details.

Each TEM is defined as a task, which is launched when a specified attribute changes in a defined context. When a TEM is triggered, it retrieves the current employee profile attributes from the BCP, and the required target values as defined by the appropriate rules.

When the TEM operation terminates, it returns details of the changed attributes, which are held in a database. The current value of each changed attribute is updated with the goal value when the task, process or entire business change completes successfully (depending on the specified requirement for the activity).

Examples of TEM tasks can be related to (but are not limited to) conventional software programs, for example: Windows NT® accounts 231; Lotus Notes accounts 233; Microsoft Exchange email accounts; Novell Netware accounts 239; and/or Email welcome greeting. Each of these examples is further described below.

With respect to Windows NT® version 4.0, developed by Microsoft Corporation of Redmond, Wash., the following exemplary TEMs can be provided: AddNTUser, ChangeNTUser, DeleteNTUser and/or ChangeNTGroup.

The TEM AddNTUser relates to adding a new NT account in an NT domain (PDC/BDC) or on an NT computer (standalone server or workstation). The TEM ChangeNTUser relates to changing NT account parameters in an NT domain (PDC/BDC) or on an NT computer (standalone or workstation). The TEM DeleteNTUser relates to deleting an existing NT user account in an NT domain (PDC/BDC) or from an NT computer (standalone or workstation). The ChangeNTGroup relates to associating an NT user to existing NT Groups in an NT domain (PDC/BDC) or on an NT computer (standalone or workstation).

With respect to Microsoft Exchange version 5.5, developed by Microsoft Corporation of Redmond, Wash., the following exemplary TEMs can be provided: AddExchangeBox, ChangeExchangeBox, DeleteExchangeBox, and/or ChangeExchangeGroups. The AddExchangeBox TEM relates to opening an Exchange mailbox for an NT user. The ChangeExchangeBox TEM relates to changing an Exchange mailbox on an Exchange server. The DeleteExchangeBox TEM relates to deleting an Exchange mailbox on an Exchange server. The ChangeExchangeGroups TEM relates to changing Exchange groups for a mailbox on an Exchange server.

With respect to Lotus Notes version 5.0, developed by Lotus Development Corp. of Cambridge, Mass., the following exemplary TEM can be provided: AddLotus, ModifyLotus, and/or DeleteLotus. The AddLotus TEM relates to opening an account in the Lotus Notes system. The ModifyLotus—relates to changing an account in the Lotus Notes system. The DeleteLotus—relates to deleting an account from the Lotus Notes system.

Exemplary Novell NetWare, developed by Novell, Inc. of Provo, Utah, TEMs can enable NetWare users to link to the BCA, and to update the NetWare directory with information about the employees created, changed or deleted in the BCA.

The following NetWare TEMs are available: SetNwUser.vbs, SetNwAccount.vbs, NewNwUser.vbs, and/or RemoveNwUser.vbs.

SetNwUser.vbs relates to updating a NetWare user account with business and personal information, such as user name, department, city and state. SetNwAccount.vbs—relates to updating the NetWare account with account information, such as password and login restrictions. NewNwUser.vbs—relates to opening a new NetWare user. RemoveNwUser.vbs—relates to deleting a user account from NetWare.

The BCA can generate an email or web-based greeting that can be printed out and put in the new employees “orientation packet,” received on the first day of employment. Typically, this email greeting is sent to the Human Resources or business manager responsible for receiving the employee on his/her first day. The email contains the initial account logins and default passwords, automatically generated by the BCA.

Data can be input to, or output from the BCA via comma separated value (CSV) files. Many databases and applications can input/data in CSV format. This TEM facilitates data transfer between relational database systems.

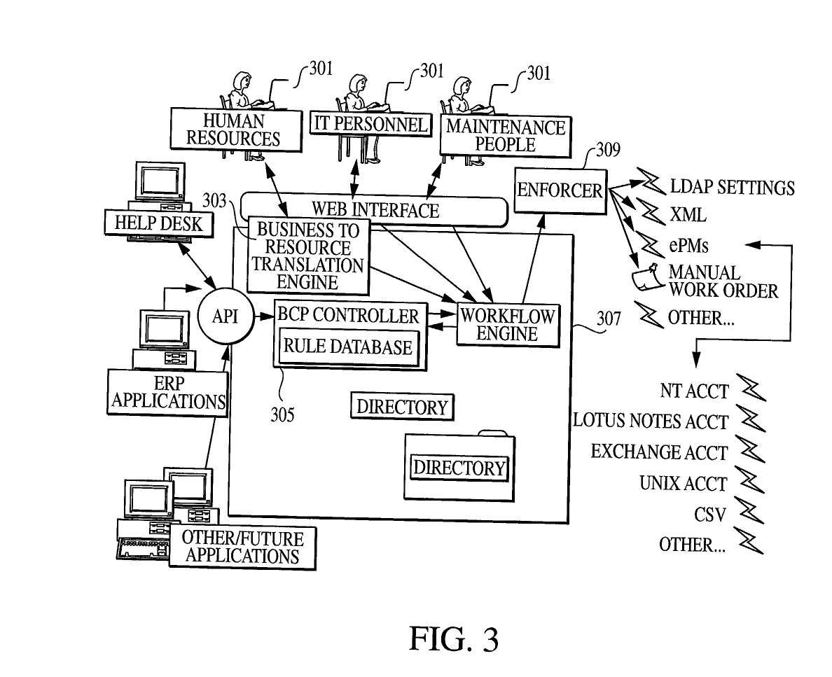

The above-described functional features of the present invention are further described in context of the software platform 102 (FIG. 1) with its associated components by referring to FIG. 3, which shows an overall technical architecture of present invention. The software platform of the present invention may be based on Windows NT® and LDAP directories.

An LDAP Directory is a primary repository for the BCA. The directory contains all the profile data of the employees and allows sharing of data with other systems. The BCA server accesses the directory using the LDAP protocol.

This makes all user-profile information (i.e., BCAs) accessible to authorized employees in a standard, secure, and reliable fashion. More importantly, it means that the BCA can directly enforce network device configurations and the set up of user accounts and group associations for many applications, simply by managing the user profiles in its LDAP directory.

Applications (e.g., the BCA) built on top of this platform can be configured to execute and manage provisioning activities based on business triggers as expressed in business rules. A business rule dictates which resources change when a business attribute (or set of business attributes) changes to a new value. These activities are composed of a set of tasks. Each task performs a single action. As an example, a process involved in setting up a new employee might entail many tasks as described above. Some of these tasks are performed manually and some of them can be automated. The automated tasks are performed using the BCA plug-ins, called TEMs, which have been described above.

During the entire process of providing resources and services, a system administrator can monitor progress using a web-based user console. The BCA's user interface is also used to display employee information. For example, employees can search for other employee's contact information, managers can initiate business changes (e.g., change of employee position or location), as well as approve tasks. The BCA allows business managers to trigger the business changes by adding/removing/editing of an individual's business profile, while allowing managers to control the business change processes.

Once tasks have been completed, the BCA stores a BCP of the individual in the LDAP directory. The BCP reflects all the changes performed in the business domain as well as in the IT domain. The BCP is stored as a regular object in the directory and is accessible from the Users Interface for later display or change.

The software platform 102 of the present invention includes the following software components: a business logic editor 301 displayed and used by various users (e.g., Human Resources, IT personnel and/or business people), Business-to-Resource Translation Engine 303, BCP controller 305, Workflow Engine 307, enforcer 309 and database 311. These components are described below in detail.

The graphics-based rule editor 301 is provided to allow system administrators to create business rules. The editor can be based upon iLOG's JRULES engine, which is a third-party rules engine as provided by iLog of Gentilly, France and Mountain View, Calif. The rule files are stored in a free-text file. Using a rule editor, the system administrator creates, and later edits the business-to-resource rules. A business change can be as simple as a name change (which may trigger an email address change) or may be quite complex as described above in connection with FIG. 2.

The BCP is a data object that contains all the attributes of a person in the organization. The BCP is stored in the LDAP directory and is accessed in various stages of the setup/change/teardown process. The BCP contains both the current value and the target value of the individuals “attributes” (e.g., current email is ‘none’, target email is ‘jsmith@abc.com’). BPs are triggered by differences between current and target values, and are completed when the current values are equal to the target values.

The BCP is comprised of several parts: definitions, actions, and profile information. The definition part of the BCP is a set of employee attributes. For example, it can be the model number of a PC, access rights to a sales database, security attributes for remote dial in, a home telephone number, etc. The action part of the BCP is a set of actions to be completed to realize a business change. For example, it can be registering a new employee with an ISP, creating a new account on the sales database, purchasing a Palm computer, and getting approval from a manager before buying the computer. The profile information part of the BCP is a set of descriptive data about the BCP. For example, it can be data about the parts of the profile that have been configured the actions the profile is allowed to perform.

Business-to-Resource Translation Engine 303 is a software component configured to translate business changes to processes/tasks. As noted above, the Business-to-Resource Translation Engine 303 can be based on changes to roles, rules and policies.

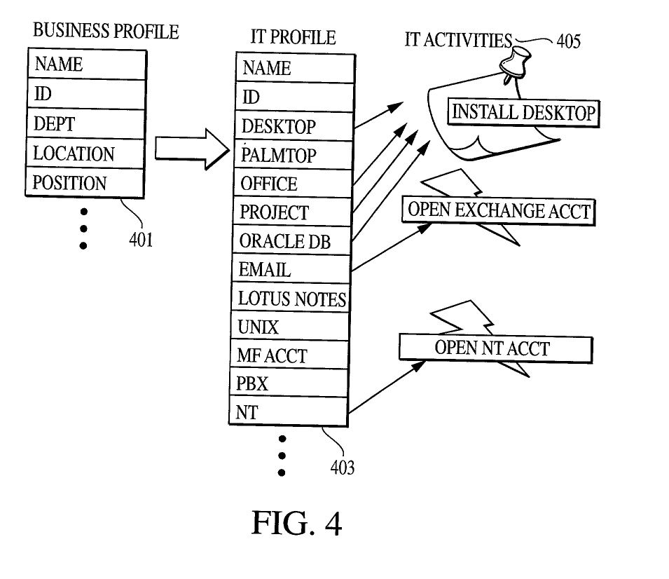

BCP Controller 305 is a software component can be written in for example MS Java. Its purpose is to translate business changes to resource changes. The BCP Controller can use an ILOG-JRULES parsing engine to parse a free-text rule file, which contains the mapping of business to resource changes. The input to the Business-to-Resource Translation Engine 303 is the rule file and an initial BCP. The output is a new BCP, where some attributes have changed (i.e., “current value” is not equal to “target value”). More specifically, referring to FIG. 4, BCP controller 305 translates business profiles 401 (e.g., name, identification number, department, location, and/or position of an employee) to IT tasks 405 (e.g., installing desktop applications, opening exchange account, and/or opening NT account) based on IT profile 403. In other words, IT profile can be associated with organizational assets. For example, if the IT profile specifies an employee has a PC, this information can directly point to a corresponding record in the asset management database. BCP controller 307 is also configured to control access to the BCP data stored therein in order to maintain the integrity of the BCP data.

As previously mentioned, such differences in BCP values trigger BPs. As an example, a business change of changing a person's department may cause additional changes in access rights, remote access permissions, application access, etc.

The Workflow Engine 307, which can be for example a Java-based service, is responsible for running and controlling BPs. This service is responsible for launching tasks, synchronizing them, collecting status reports and following the BP as it progresses through a workflow. The workflow may contain approvals, escalations, failures, retries, etc. The Workflow Engine 307 is also responsible for activating automated tasks and tracking their execution. Workflow Engine 307 communicates with the rest of the BCA using a persistent messaging queue, like Microsoft's MSMQ.

Microsoft MSMQ is the message bus connecting the entire application. MSMQ is used as a persistent, asynchronous message-oriented channel connecting the various processes. The use of MSMQ persistency options, strengthens the robustness of the application against system failures or even reboots.

The Workflow Engine 307 is responsible for the following operations: tracking and logging to database 311 all activities in embodiments of the present invention; notifying personnel when they have a task; escalating tasks to managers when they are not completed on time; interleaving manual and automated tasks with approval processes for each stage of IT activity; Interacting with 3rd party systems (e.g., business systems like HR applications and IT systems like help desks); interacting with individuals via email and via wireless media (future); interacting with external organizations (e.g., ASPs, ISPs, suppliers, etc.); and/or prioritizing processes (e.g., it may be much more important to get one employee up and running over another).

Enforcer module 309 enables the BCA to interact with the surrounding environment of business and IT applications. This interaction might be responding to business events triggered on other systems, or creating user accounts on IT systems. Some specific examples of enforcement include the following:

1. Manual work order—an email message telling an IT staff member to set up a new computer for Employee X, who will be starting next Wednesday. Additionally, the work order will appear in the IT staff member's “To Do” list.

2. An interface to a third party software package (e.g., Peoplesoft HR application) allows the BP to begin automatically when a new employee is entered into the third party software package.

3. A TEM to Windows NT® allows automatic configuration of an employee's NT account, including domain association.

4. A TEM to a PBX may allow automatically configuring an employee's user profile as the direct outcome of task. In this case, the TEM is a small executable file/script that performs IT activities on remote stations. After completion of the IT task, the TEM sends a completion message to the MSMQ and exits.

As noted above, TEMs communicate with the rest of the software platform using COM objects. The process lifecycle begins when launched by the Workflow Engine 307.

With respect to database 311, the BCA uses, for example, an SQL (Structured Query Language) database to store essential system settings, runtime data and configuration data. The SQL server is also a temporary storage place for BCPs while they are in a state of change.

The BCA maintains a log containing provisioning event, system alert and failure. The log is stored in database 311 and can be configured to filter out specific events. Using the log, an administrator can track changes across long periods of time.

The embodiment of the present invention log all the business and IT-related activities, including the following:

1. New people, terminated people, people moved, or changes made to personnel profiles.

2. All activities emanating from a specific business change. For example, when an employee leaves the company, it is possible to see all the resources allocated, as well as the business reason the employee had the resources in the first place.

3. Time stamps of activities, so that performance analysis can be performed on activities. For example, logs can be generated that highlight the activities that most often do not meet performance expectations, etc.

It should be noted that the BCA includes a (Microsoft IIS 4.0 or other) web server, which also serves as the application server.

Now referring back to FIG. 2 to describe the report generation 213 step, a report generator is provided with the BCA. The report generator can be an OEM version of Crystal Decision's (previously Seagate Software of Vancouver, B.C., Canada) Crystal Reports. Reports can be viewed via the web client, or can be printed for inclusion in company reports.

Several types of reports are supported, including tabular and analysis reports. Some examples of reports include the following:

Employee Workload—provides a breakdown of the time spent on activities, and the time still needed to perform on activities, for each employee.

Activity Delays—provides a breakdown of the tasks in the organization whose status is Overdue, for example, the types of tasks and the number of days they are overdue.

Activities per Department—provides a breakdown of the current activities in the department, for example, their types and statuses.

Activities per Site—provides a breakdown of the current activities in the site, for example, their holders and the departments to which they belong.

Status—provides a breakdown of the activities in the organization, according to their statuses, for example, IT Preview and Created.

Running Tasks—provides a breakdown of the tasks in the organization that are currently running.

Costs—a summary of costs associated with IT activities. This report helps the IT manager accurately track the IT cost of setup/teardown and changes. This is particularly helpful for automating the calculation of accurate chargebacks for resources and services used by organizational departments.

Costs per Employee—a summary of costs for activities performed for a specified set of employees.

Task Completion Percentages—a breakdown of the percentage of completed tasks vs. uncompleted tasks, for a specified set of employees.

A system administrator or If manager can create new reports using any of the profile data, log database information, or other system data. A default set of reports is provided with the product. These reports can be customized to include company logos, to change displayed data fields, or to change the sort order of existing data. Additionally, new reports can be created and incorporated into the product “on site.”

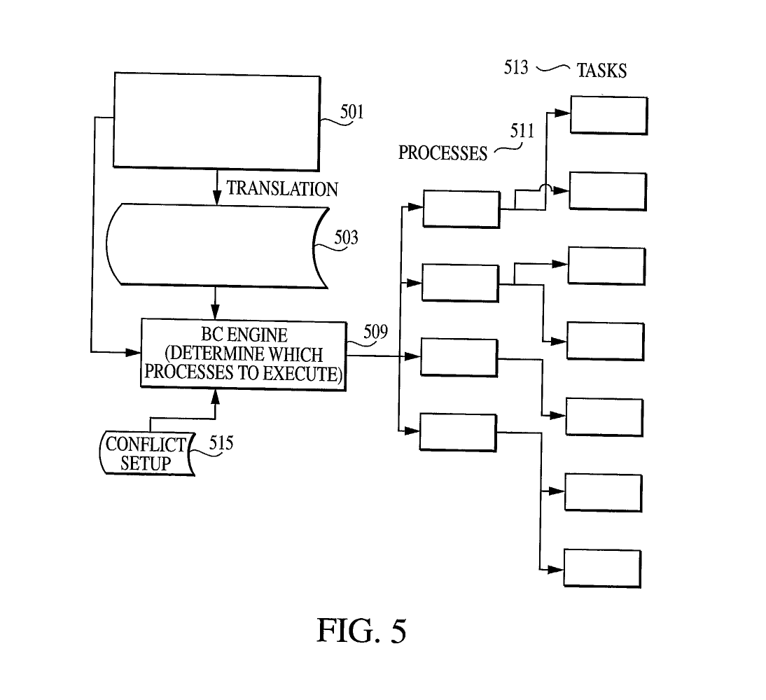

Relationships among the BPs, the BCA and other components described above are described in more detail by referring to FIG. 5. In particular, business change 501 is expressed directly by an end user (either via the BCA, via a third party business application, like a human resources application, or via a software “gateway” that facilitates bulk business changes). Three exemplary types of business changes (i.e., “new”, “change”, and “remove”) operate as follows:

1. The “new” business change relates to the addition of a new employee.

2. The “change” business change relates to a change to the profile of an employee.

3. The “remove” business change relates to the removal of an employee.

Note that each type of change can relate to any type of employee, whether it is an employee, a partner or any other type of employee supported in the BCA.

Other types of business changes such as “suspend” and “resume” are contemplated within embodiments of the present invention. It is important to note, however, that embodiments of present invention are flexible enough to allow any number of business changes and there is no limitation to the number of business change types that are supported.

A BCP 503 object represents the status of an employee while this employee is undergoing a business change. Each employee that is handled by embodiment of the present invention is associated with such a BCP. The BCP represents the user data and the changes through which the employee goes.

The BCP includes a set of data, or “attributes.” These attributes and their associated values represent the “current” and “target” states of the employee, for every relevant characteristic (including business characteristics or digital characteristics).

As noted above, a business process (BP) is the basic entity of execution for a business change. Any change that requires either automatic or manual action to be taken is represented by a process. The BP is invoked by changes in attribute values (in the BCP) and is composed of tasks. The execution of a BP is triggered by a change in an employee's BCP.

A task is responsible for implementing an action. There are preferably two types of tasks: manual and automatic. Manual tasks are executed by sending messages to the people or groups of people who are assigned to perform the action. Automatic tasks invoke the Workflow Engine 307 that execute the needed action without human intervention. An example of a manual task is installing a telephone. An example of an automated task is creating a user account within a network operating system.

When a business change is invoked for an employee (usually “new”, “change” or “remove”), a translation process begins, in which predefined business rules are interpreted and used to set appropriate values to the employee's BCP.

When the translation process completes, the BCP has a set of “current values” 505 and “target values” 507. The “current values” 505 represent the values that the employee has for all their defined attributes, prior to the business change. The “target values” 507 represent the attribute values that should replace the current values, as a result of the business change.

As the current values are changed to the target values, the target values are deleted. When there are no target values left, it signifies the completion of the business change that generated the target values.

Now the process of changing values from current to target begins. This is the process that initiates the Workflow Engine 307.

The BCP Controller software component evaluates all the BCP attributes. For those in which the “target” value is different from the “current” value, it selects one of the following two options:

1. The attribute is not associated with any BP. In this case, the “target” value is simply copied to the “current” attribute, and the change is reflected in the Directory (i.e., the data store).

2. The attribute is associated with a BP. In this case, the value will not “move” from the “target” status to the “current” status unless the associated “process” has finished successfully. We say that the attribute “depends on” the BP.

During a system configuration, a system administrator associates attributes with each of the defined BPs. The association between an attribute and a BP may also take into account another parameter—the associated business change. Each BCP is associated with a business change that invoked it, for example “new”, or “change”. The association between an attribute and a BP may be defined independently of the relevant Business Change (and then the process is invoked no matter which Business Change is associated with the BCP), or dependent on the Business Change. In this case, the process will be invoked only if the Business Change associated with the BCP is of the right type (such as “new”, or “change”).

After a process (e.g., a BP) had been invoked, its corresponding tasks are invoked. The process is now detached from the attribute values, and continues according to the state machine, which defines a process workflow. It then goes through all the steps defined in the state machine, through approvals, escalations, etc. These states are described later.

After the BP has been successfully completed, the BCP Controller sets the “current” value of the attribute to be the same as the “target”, and updates the directory accordingly.

This same procedure takes place for each and every attribute in the BCP, invoking as many BPs as needed. During all this time of processing, the BCP remains in an “active” state. Only after all the processing has finished the BCP becomes “static” and no differences exist between “target” and “current” values. Then the BCP is ready to be archived, and the workflow has completed (until the next attribute change).

As several attributes may change in the BCP during a business change, conflicts between different activities may arise. Such conflicts occur when different attribute values cause different processes to be invoked. For example, a conflict will occur if a change in one attribute causes the “Create new account” process to be invoked, and another one caused the “Change account” to be invoked.

There is a special mechanism (e.g., conflict setup 515) in the BCA for resolving conflicts. During system configuration, all possible conflicts are mapped, and the exact “conflict policy” to be chosen is selected. The conflict always involves two BPs, and one of them is defined as the “conflicting” one. Then, the policy could be to ignore the conflicting one, ignore the other one, execute both, or execute none of them. The embodiments of the present invention are flexible and new “conflict policies” may be defined and used.

In the example above, it could be defined so that in case of such conflict the “Create new account” process would take over, and the other process would not be executed at all.

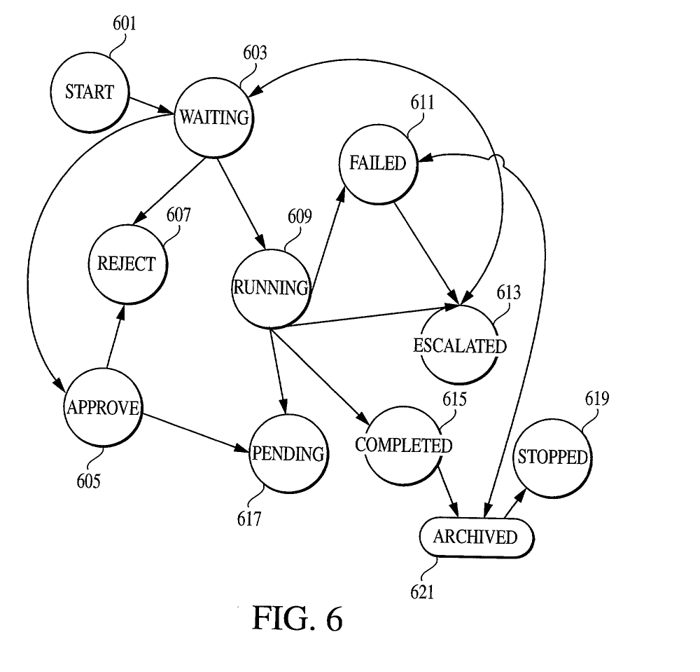

As described above in connection with FIG. 3, Workflow Engine 307 runs and controls BPs. Each BP, once triggered, includes various states in its life cycle, which is controlled by Workflow Engine 307. The various states of a process/task are described below in detail by referring to FIG. 6.

More specifically, initially a process/task is created (e.g., instantiated) and put into a start state 601. In start state 601, the process/task is instantiated to be executed by Workflow Engine 307. In some embodiments of the present invention, the start state 601 is entered only after an initial set of data becomes available.

The process/task is then put into a waiting state 603 to be approved. An employee with appropriate authority (e.g., a business manager or system administrator) may approve the process/task in waiting state 603. It should be noted that the person with the authority may approve process/task one at a time or groups of processes/tasks at a time. Once the process/task in the waiting state 603 has been approved, the process/task is put into a pending state 617. If not approved, the process/task is put into a reject state 607 and then reported as such.

In pending state 617, the process/task waits for data to become available. The data in this context is data that may be required to perform the process/task. For instance, in order to open an e-mail account, the account name of the person for whose the account is being opened is required.

Once the data becomes available, the process/task is put into a running state 609. While in running state 609, the process/task is executed, after which the process/task is put into a completed state 619. If the process/task is not executed during a predefined time period (e.g., few minutes to days), then the process/task is put into an escalated state 613. As noted above, escalated state 613 causes an investigation, corrective actions and/or retries. If the process/task fails due a system failure (e.g., lack of resources), the process/task is put into a failed state 611. Such process/task is retried in the escalated state 613. Also, after a predetermined number of retries, if the process/task continues to fail, then the process/task it put into an archived state 621. After a successful completion of the task/process, it is put into the archived state 621. In the archived state, the status of process/task is logged into database 311, then the process/task is put into a stopped state 619, which designates a completion of the process/task.

A business change is also provided with a life cycle that includes a number states, a subset of which are substantially similar to the states described above. More specifically, in addition to the states that are similar to the process/task states, the life cycle for a business change further includes: a start state, approval state, profile generation state, process creation state, and session creation state.

During the start state, a business change is instantiated, which is then put into the approval state to be approved. Once approved, a profile is generated in the profile generation state. A session is created for the business change in the session state. Once the profile and session are created, the business change is put into the process creation state, during which processes/task are created.

Workflow Engine 307 runs and controls all created business changes, processes, and tasks by managing the states of each instantiated business changes, processes, and tasks. For instance, Workflow Engine 307 stores the status of each state, data to be logged after a successful/unsuccessful execution of processes/tasks, etc. in database 311.

In general, it should be emphasized that the various components of embodiments of the present invention can be implemented in hardware, software or a combination thereof. In such embodiments, the various components and steps would be implemented in hardware and/or software to perform the functions of embodiments of the present invention. Any presently available or future developed computer software language and/or hardware components can be employed in such embodiments of the present invention.

The many features and advantages of embodiments of the present invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A computer-assisted method of allocating resources within an organization, the method comprising the steps of:
(a) receiving a request containing at least one business change relating to allocating the resources within the organization;
(b) generating at least one task to implement the requested business change;
(c) identifying at least one of a person capable of handling the at least one task and a software module configured to perform the at least one task; and
(d) issuing at least one instruction to the at least one of a person capable of handling the at least one task and a software module configured to perform the at least one task, to thereby allocate the resources within the organization in accordance with the at least one business change.

2. The method of claim 1, wherein step (a) further comprises at least one step of:
receiving a request containing at least one business change directed to adding an employee to the organization;
receiving a request containing at least one business change directed to removing an employee from the organization;
receiving a request containing at least one business change directed to moving an employee from one location to another within the organization; and
receiving a request containing at least one business change directed to temporarily adding an employee to the organization.

3. The method of claim 1, wherein step (a) further comprises the step of:
receiving a request containing at least one business change directed to adding a plurality of employees to the organization, wherein the plurality of employees includes at least one group of employees each designated to receive a predetermined set of resources.

4. The method of claim 3, wherein the predetermined set of resources includes at least one of a cell phone account, a computer and an access to a software application.

5. The method of claim 1, further comprising the step of:
observing the at least one instruction being performed by the at least one of a person capable of handling the at least one task and a software module configured to perform the at least one task.

6. The method of claim 1, further comprising the step of:
causing an investigation when the at least one instruction fails to be performed by the at least one of a person capable of handling the at least one task and a software module configured to perform the at least one task.

7. The method of claim 1, further comprising one step of:
approving the at least one instruction to be performed by the at least one of a person capable of handling the at least one task and a software module configured to perform the at least one task; and
disapproving the at least one instruction to be performed by the at least one of a person capable of handling the at least one task and a software module configured to perform the at least one task.

8. The method of claim 1, further comprising the steps of:
determining whether a conflict exists among the at least one instruction; and
resolving the conflict based on a predetermined policy when the conflict is determined to exist, wherein the predetermined policy includes at least one rule directing at least one of the at least one instruction to be performed.

9. A system of allocating resources within an organization, the system comprising:
(a) means for receiving a plurality of requests each containing at least one business change relating to allocating the resources within the organization;
(b) means for generating at least one task to implement the requested business change;
(c) means for identifying at least one of a person capable of handling the at least one task and a software module configured to perform the at least one task; and
(d) means for issuing at least one instruction to the at least one of a person capable of handling the at least one task and a software module configured to perform the at least one task, to thereby allocate the resources within the organization in accordance with the at least one business change.

10. The system of claim 9, wherein the business charge comprises at least one of:
adding an employee to the organization;
removing an employee from the organization;
moving an employee from one location to another within the organization; and
temporarily adding an employee to the organization.

11. The system of claim 9, wherein the business charge is directed to adding a plurality of employees to the organization, wherein the plurality of employees includes at least one group of employees each designated to receive a predetermined set of resources.

12. The system of claim 11, wherein the predetermined set of resources includes at least one of a cell phone account, a computer and an access to a software application.

13. The system of claim 9, further comprising:
means for observing the at least one instruction being performed by the at least one of a person capable of handling the at least one task and a software module configured to perform the at least one task.

14. The system of claim 9, further comprising:
means for causing an investigation when the at least one instruction fails to be carried out by the at least one of a person capable of handling the at least one task and a software module configured to perform the at least one task.

15. The system of claim 9, further comprising:
means for determining whether a conflict exists among the at least one instruction; and
means for resolving the conflict based on a predetermined policy when the conflict is determined to exist, wherein the predetermined policy includes at least one rule directing at least one of the at least one instruction to be performed.

16. A computer readable medium for storing instructions being executed by one or more computers, the instructions directing the one or more computers for allocating resources within an organization, the instructions comprising implementation of the steps of:
(a) receiving a request containing at least one business change relating to allocating the resources within the organization;
(b) generating at least one task to implement the requested business change;
(c) identifying at least one of a person capable of handling the at least one task and a software module configured to perform the at least one task; and
(d) issuing at least one instruction to the at least one of a person capable of handling the at least one task and a software module configured to perform the at least one task, to thereby allocate the resources within the organization in accordance with the at least one business change.

17. The medium of claim 16, wherein step (a) further comprises at least one step of:
receiving a request containing at least one business change directed to adding an employee to the organization;
receiving a request containing at least one business change directed to removing an employee from the organization;
receiving a request containing at least one business change directed to moving an employee from one location to another within the organization; and
receiving a request containing at least one business change directed to temporarily adding an employee to the organization.

18. The medium of claim 16, wherein step (a) further comprises the step of:
receiving a request containing at least one business change directed to adding a plurality of employees to the organization, wherein the plurality of employees includes at least one group of employees each designated to receive a predetermined set of resources.

19. The medium of claim 18, wherein the predetermined set of resources includes at least one of a cell phone account, a computer and an access to a software application.

20. The medium of claim 16, further comprising the instructions comprising implementation of the step of:
observing the at least one instruction being carried out by the at least one of a person capable of handling the at least one task and a software module configured to perform the at least one task.

21. The medium of claim 16, further comprising the instructions comprising implementation of the step of:
causing an investigation when the at least one instruction fails to be carried out by the at least one of a person capable of handling the at least one task and a software module configured to perform the at least one task.

22. The medium of claim 16, further comprising the instructions comprising implementation of one step of:
approving the at least one instruction to be carried out by the at least one of a person capable of handling the at least one task and a software module configured to perform the at least one task; and
disapproving the at least one instruction to be carried out by the at least one of a person capable of handling the at least one task and a software module configured to perform the at least one task.

23. The medium of claim 16, further comprising the instructions comprising implementation of the steps of:
determining whether a conflict exists among the at least one instruction; and
resolving the conflict based on a predetermined policy when the conflict is determined to exist, wherein the predetermined policy includes at least one rule directing at least one of the at least one instruction to be performed.
